(19) United States
(12) Patent Application Publication
(10) Pub. No.: US 2014/0154410 A1
(43) Pub. Date: Jun. 5, 2014

(54) LARGE SURFACE SUPPORTED MOLECULAR SIEVE MEMBRANE

(71) Applicants: Akhil Agarwal, Beaumont, TX (US); Joseph Marshall Mayne, Houston, TX (US); Brendan Dermot Murray, Houston, TX (US); Chen Elizabeth Ramachandran, Houston, TX (US); Paul Jason Williams, Richmond, TX (US)

(72) Inventors: Akhil Agarwal, Beaumont, TX (US); Joseph Marshall Mayne, Houston, TX (US); Brendan Dermot Murray, Houston, TX (US); Chen Elizabeth Ramachandran, Houston, TX (US); Paul Jason Williams, Richmond, TX (US)

(21) Appl. No.: 14/237,582

(22) PCT Filed: Aug. 7, 2012
(86) PCT No.: PCT/EP2012/065400

§ 371 Date: Feb. 7, 2014

Related U.S. Application Data
(60) Provisional application No. 61/521,468, filed on Aug. 9, 2011.

(51) Int. Cl. B01D 67/00

(52) U.S. Cl. CPC B01D 67/0051
USPC 427/180; 427/244; 118/58

(57) ABSTRACT

A method including preparing a molecular sieve material in a first chamber; transferring the molecular sieve material from the first chamber to a second chamber comprising at least one support; in the second chamber, contacting the at least one support with the molecular sieve material under conditions that promote the crystallization of molecular sieve material on the at least one support; and synthesizing crystals of molecular sieve material on the at least one support. A system including a first chamber defining a volume sufficient to accommodate a volume of molecular sieve material, an inlet and an outlet; a heating element coupled to the first chamber; and a second chamber comprising a pair of inlets and defining a volume sufficient to accommodate a support.

### BACKGROUND

1. Field

Silicoaluminophosphate (SAPO) membranes, aluminophosphate (AlPO) membranes, and molecular sieve membranes.

2. Background Information

Natural gas is a fuel gas used extensively in the petrochemical and other chemicals businesses. Natural gas is comprised of light hydrocarbons-primarily methane, with smaller amounts of other heavier hydrocarbon gases such as ethane, propane, and butane. Natural gas may also contain some quantities of non-hydrocarbon “contaminant” components such as carbon dioxide and hydrogen sulfide, both of these components are acid gases and can be corrosive to pipelines.

Natural gas is often extracted from natural gas fields that are remote or located off-shore. Conversion of natural gas to a liquid hydrocarbon is often required to produce an economically viable product when the natural gas field from which the natural gas is produced is remotely located with no access to a gas pipeline. One method commonly used to convert natural gas to a liquid hydrocarbon is to cryogenically cool the natural gas to condense the hydrocarbons into a liquid. Another method that may be used to convert natural gas to a liquid hydrocarbon is to convert the natural gas to a synthesis gas by partial oxidation or steam reforming, and subsequently converting the synthesis gas to liquid hydrocarbons, such as that produced by a Fisher-Tropsch reaction. Synthesis gas prepared from natural gas may also be converted to a liquid hydrocarbon oxygenate such as methanol.

In a cryogenic cooling process to liquefy hydrocarbons in natural gas, carbon dioxide may crystallize when cryogenically cooling the natural gas, blocking valves and pipes used in the cooling process. Further, carbon dioxide utilizes volume in a cryogenically cooled liquid hydrocarbon/carbon dioxide mixture that would preferably be utilized only by the liquid hydrocarbon, particularly when the liquid hydrocarbon is to be transported from a remote location.

Carbon dioxide also may impair conversion of natural gas to a liquid hydrocarbon or a liquid hydrocarbon oxygenate. Significant quantities of carbon dioxide may impair conversion of natural gas to synthesis gas by either partial oxidation or by steam reforming.

As a result of the corrosive nature of carbon dioxide and the additional difficulty of processing natural gas contaminated with carbon dioxide, attempts have been made to separate carbon dioxide present in a natural gas from the hydrocarbon components of the natural gas prior to processing the natural gas to a liquid. Separation techniques include scrubbing the natural gas with a liquid chemical, e.g. an amine, to remove carbon dioxide, passing the natural gas through molecular sieves selective to separate carbon dioxide from the natural gas. These methods of separating carbon dioxide from a natural gas are effective for natural gases containing 40 percent by volume of carbon dioxide, more typically less than 15 to 30 percent by volume, but are either ineffective or commercially prohibitive in energy costs to separate carbon dioxide from natural gas when the natural gas is contaminated with larger amounts of carbon dioxide, e.g., at least 40 percent by volume.

Production of natural gas from natural gas fields containing natural gas contaminated with on the order of 50 percent by volume or more carbon dioxide is generally not undertaken due to the difficulty of producing liquid hydrocarbons or liquid hydrocarbon oxygenates from natural gas contaminated with such large quantities of carbon dioxide and the difficultly of removing carbon dioxide from the natural gas when present in such a large quantity. However, some of the largest natural gas fields discovered to date are contaminated with high levels of carbon dioxide. Therefore, there is a need for an energy efficient, effective method to separate carbon dioxide from a natural gas contaminated with carbon dioxide, including a carbon dioxide rich natural gas.

Laboratory studies of silicoaluminophosphate (SAPO) and/or aluminophosphate (AlPO) containing membranes, particularly SAPO-34 containing membranes, have demonstrated utility in separating carbon dioxide (CO₂) or hydrogen sulfide (H₂S) from contaminated natural gas. Formation of such membranes involves forming SAPO-34 crystals typically from a synthesis gel in and on a porous support at an elevated temperature and under autogenous pressure. Forming larger scale, equivalent membranes present challenges in part because of the nature in which SAPO-34 crystals are formed and the ability to control the formation conditions.

Currently, SAPO containing membranes are formed in a static autoclave system. Representatively, a seeded membrane support (e.g., ceramic or metal support) is soaked in a molecular sieve material (synthesis gel) for a period of time (e.g., one to four hours) and then the molecular sieve material and support are heated to a temperature greater than 150° C. under autogenous pressure for five to six hours to form the SAPO containing membranes. The membrane is then cooled and separated from the synthesis gel, rinsed and dried. Finally, the membrane is calcined to remove any templating agent(s) that were present in the molecular sieve material.

The static reaction described above for crystalline synthesis of a molecular sieve material requires a support to be in contact with molecular sieve material (e.g., a SAPO synthesis gel). Once a SAPO crystal containing membrane is formed, the membrane is similarly present in the molecular sieve material, in depleted or spent molecular sieve material. The spent molecular sieve material tends to stratify with regions of increased pH and molecular sieve crystals such as SAPO or AlPO crystals tend to be more soluble at a high pH. Commonly owned U.S. Provisional Patent Application No. 61/431,990 recognized this concern and describes a process wherein a molecular sieve membrane was rapidly disassociated with depleted or spent molecular sieve material once the membrane was formed.

### SUMMARY

In one embodiment, a method is disclosed. The method includes preparing a molecular sieve material such as a silicoaluminophosphate (SAPO) and/or an aluminophosphate (AlPO) gel in a first chamber; transferring the molecular sieve material from the first chamber to a second chamber including a support. In the second chamber, the method includes, contacting the support with the molecular sieve material under conditions that promote crystallization of molecular sieve material on the support; and synthesizing crystals of molecular sieve material on the support. Representatively, the transferring of the molecular sieve material from the first chamber to the second chamber continues until a predetermined synthesis end point is reached on the support. To this objective, the molecular sieve material may be circulated between the first chamber and the second chamber resulting in a circulated reactor system to synthesize a molecular sieve membrane.

In another embodiment, a system is disclosed, such system being suitable for operating a molecular sieve membrane synthesis. In still another embodiment, the system is suitable for operating a circulated reaction system. Representatively, the system includes a first chamber defining a volume sufficient to accommodate a volume of molecular sieve material, an inlet and an outlet; a heating element coupled to the first chamber; an impeller disposed in the first chamber; and a second chamber comprising a pair of inlets and defining a volume sufficient to accommodate a molecular sieve membrane support that has a length dimension with at least one lumen therethrough. An exterior surface of such a molecular sieve membrane support defines a shell side and an interior surface of the support defined by the at least one lumen defines a bore side. Accordingly, when a molecular sieve membrane support is accommodated in the second chamber, a first of the pair of inlets in the second chamber is positioned to be in fluid communication with a bore side of the support and a second of the pair of inlets is positioned to be in fluid communication with a shell side of the support.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a top perspective view of an embodiment of a silicoaluminophosphate (SAPO) membrane.

FIG. 2 is a side end view of another embodiment of a SAPO membrane.

FIG. 3 is a schematic flow diagram of an embodiment of a system to prepare a molecular sieve membrane.

FIG. 4 is perspective side view of an embodiment of a tube bundle of 10 supports to be accommodated in a reaction chamber.

FIG. 5 is top view of the tube bundle of FIG. 4.

FIG. 6 is a cross-sectional perspective view of an embodiment of a connection between a tubesheet of a tube bundle and a support.

FIG. 7 is a cross-sectional perspective view of another embodiment.

FIG. 8 is a cross-sectional side view of a reaction chamber containing a tube bundle of supports and showing flow patterns of molecular sieve material within the reaction chamber.

FIG. 9 is a flow chart of forming a molecular sieve membrane.

### DETAILED DESCRIPTION

In one embodiment, a system and method are described for forming a molecular sieve membrane such as a silicoaluminophosphate (SAPO) and/or aluminophosphate (AlPO) membrane having a layer or layers of SAPO and/or AlPO crystals. Membranes are suitable, in one embodiment, to separate components of a gas stream. Particularly, in one embodiment, a SAPO-34 membrane may be used to remove contaminants such as carbon dioxide from a natural gas stream. Although SAPO and AlPO molecular sieve materials and membranes are referenced herein, it is appreciated that the system and method described have applications for other molecular sieve materials, including but not limited to zeolites.

The system and method describe separating a molecular sieve material or synthesis gel from a reaction chamber or vessel in which membrane crystals will be formed in or on a support to form a membrane until such time as contact between the molecular sieve material and the support is desired. In this manner, molecular sieve material may be prepared according to desired reaction parameters, optionally including mixing, in a preparation chamber or first chamber and then transferred to a reaction chamber or second chamber containing the support. The transfer of molecular sieve material may continue until a predetermined synthesis end point is reached on the support (e.g., a molecular sieve membrane is formed). In one embodiment, the transfer of molecular sieve material results in a flow of the material through the reaction chamber in contact with the support. In one embodiment, the flow of molecular sieve material is continuous and may be circulated from the preparation chamber to the reaction chamber and then back to the preparation chamber. In one embodiment, the molecular sieve material is circulated through two or more reaction chambers in series and/or in parallel before returning to the preparation chamber.

By transferring (flowing) molecular sieve material from the preparation chamber to the reaction chamber, the molecular sieve material near the support is well mixed both inside and outside of the lumen(s) of the support tube(s). In traditional impeller mixed systems, mixing inside the lumens can be limited by geometric and flow restrictions. This mixing is also better than in unstirred systems where inhomogeneity in the molecular sieve material can be an issue inhibiting uniform membrane growth. In one embodiment, a circulated system and method is described wherein a molecular sieve material is transferred from a first or preparation chamber to a second or reaction chamber containing the support and circulated from the reaction chamber back to the preparation chamber. Once a desired synthesis end point is reached, such circulation may be stopped and any molecular sieve material (e.g., spent molecular sieve material) remaining in the reaction chamber at the end point may be returned to the preparation chamber or directed to a receiver. Volatile components of the molecular sieve material in the reaction chamber may also be flashed from the reaction chamber.

In one embodiment, the spent molecular sieve material is removed from the membrane surfaces in the reaction chamber to minimize any membrane dissociation due to contact with spent material. In this manner, at a predetermined synthesis end point or shortly thereafter, contact between molecular sieve crystals of the membrane and molecular sieve material (synthesis gel) can be minimized because remaining molecular sieve material in the reaction chamber may be transferred to the preparation chamber or a receiver. One method to aid transfer is via pressurized water or steam flush of the remaining molecular sieve material through the reaction chamber and into a receiver. This can also be carried out with the aid of external cooling to rapidly quench the crystallization process and to allow for faster separation of molecular sieve material from the molecular sieve membrane.

It is also believed that the flashing of the molecular sieve material will lower the pH of the material thus reducing the adverse effects of contact with the molecular sieve material on the membrane. Flashing also will reduce the pressure in the reaction chamber and the temperature, which it is also believed will reduce the adverse effect of contact between the molecular sieve material and the membrane. Thus, it is believed immediate flashing of the reaction chamber (i.e., at the synthesis end point or within a few minutes of the synthesis end point) will allow contact between the molecular sieve material (e.g., spent molecular sieve material) and the membrane to be sustained at least for a short period, e.g., one minute to several minutes, without adverse effects to the membrane. The molecular sieve membrane (e.g., SAPO and/or AlPO containing membrane) may be washed while it is in the reaction chamber to cool quickly and to separate molecular sieve material from the molecular sieve membrane surface.

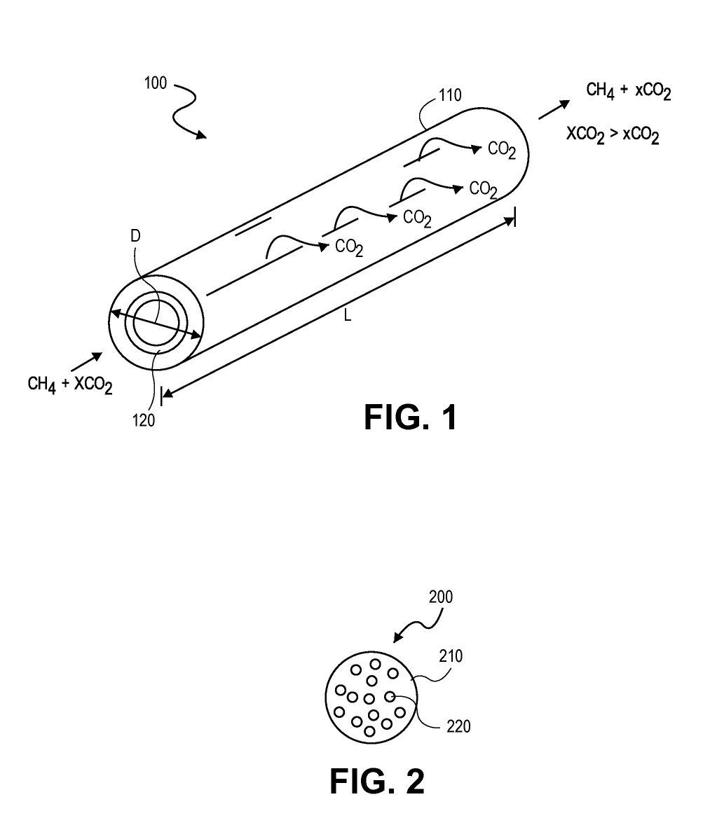

FIG. 1 shows a top, perspective view of a molecule sieve membrane including SAPO and/or AlPO crystals formed in and/or on a support. Membrane 100 includes a support 110 that, in this embodiment, is a tube having a lumen (channel) therethrough. Support 110 is a body capable of supporting a SAPO and/or AlPO material to form a SAPO and/or AlPO membrane. In one embodiment, support 100 has a length on the order of about one meter and an outside diameter of 10 millimeters. Lengths longer or shorter than one meter and outside diameters greater than or less than 10 millimeters are also contemplated to the extent that such supports may be utilized in a commercially-viable process of, for example, separating a component or components from a gas stream.

Although a tubular structure is shown in FIG. 1, the support may be another shape suitable for the particular commercial environment, such as a flat plate or disc. The support may also be a hollow fiber support. FIG. 1 shows an embodiment of support 110 as a tubular structure with a single lumen or channel. In another embodiment, illustrated in FIG. 2, a tubular structure may have multiple lumens or channels. FIG. 2 shows membrane 200 including support 210 having multiple lumens or channels. It is appreciated that the lumens or channels may have a variety of cross-sectional shapes. FIG. 2 shows channels having a circular cross-sectional shape. Such shapes could alternatively be, for example, rectangular, oval or some combination of shapes.

Referring again to FIG. 1, representatively, support 110 is a porous metal, ceramic or other porous inorganic material on which SAPO and/or AlPO crystals are grown or on which a SAPO and/or AlPO material or precursor can be deposited. Suitable inorganic supports include alumina, titania, zirconia, carbon, silicon carbide, clays or silicate minerals, aerogels, supported aerogels, and supported silica, titania and zirconia and combinations thereof. Suitable inorganic supports also include pure SAPO and/or AlPO or combinations of the previously listed materials with SAPO and/or AlPO. Suitable metal supports include, but are not limited to, stainless steel, nickel based alloy, iron chromium alloys, chromium and titanium.

In one embodiment, support 110 is comprised of an asymmetric porous ceramic material, where the layer onto which the SAPO and/or AlPO molecular sieve crystals are formed has a mean pore diameter greater than about 0.1 microns. Representative acceptable mean pore diameters for commercial application include, but are not limited to, 0.005 microns to 0.6 microns.

A support that is a metal material may be in the form of a fibrous-mesh (woven or non-woven), a combination of fibrous mesh with sintered metal particles, and sintered metal particles. In one embodiment, the metal support is formed of sintered metal particles. In another embodiment, support 110 is a porous ceramic or a porous metal hollow fiber formed from any method known in the art.

Referring to FIG. 1, a circumference of the lumen or channel of support 110 is covered with a layer or layers of SAPO and/or AlPO molecular sieve crystals. FIG. 1 shows layer 120. It is appreciated that layer 120 may represent a single layer or multiple layers. In one embodiment, layer 120 includes SAPO-34 crystals. In one embodiment, the crystals cover ideally the entire inner circumference of tubular support. A representative thickness of layer 120 is on the order of 100 nanometers to ten microns more preferably 0.5 to six microns.

The SAPO and/or AlPO molecular sieve crystals may embed themselves in the pores of the porous support as well as form on the support thus reducing an inner diameter of support 110. Although shown as a defined layer in FIG. 1, it is appreciated that the layer represents a continuous collection of crystals embedded in and on support 110. Referring to the embodiment shown in FIG. 2, SAPO and/or AlPO crystals 220 line the inside of the multiple channels of support 210.

FIG. 1 illustrates a use of membrane 100 including SAPO-34 crystals in and on support 110. In this illustration, a methane gas feed stream contaminated with carbon dioxide is fed into the lumen or channel of support 110 of membrane 100. Carbon dioxide in the feed stream is selectively removed from the methane gas as the gas passes through membrane 100. FIG. 1 shows carbon dioxide (CO₂) molecules being removed through support 110. The methane gas exits the lumen or channel at an end opposite an entrance of the gas feed stream. The methane gas exits membrane 100 with a reduced amount of carbon dioxide contaminant.

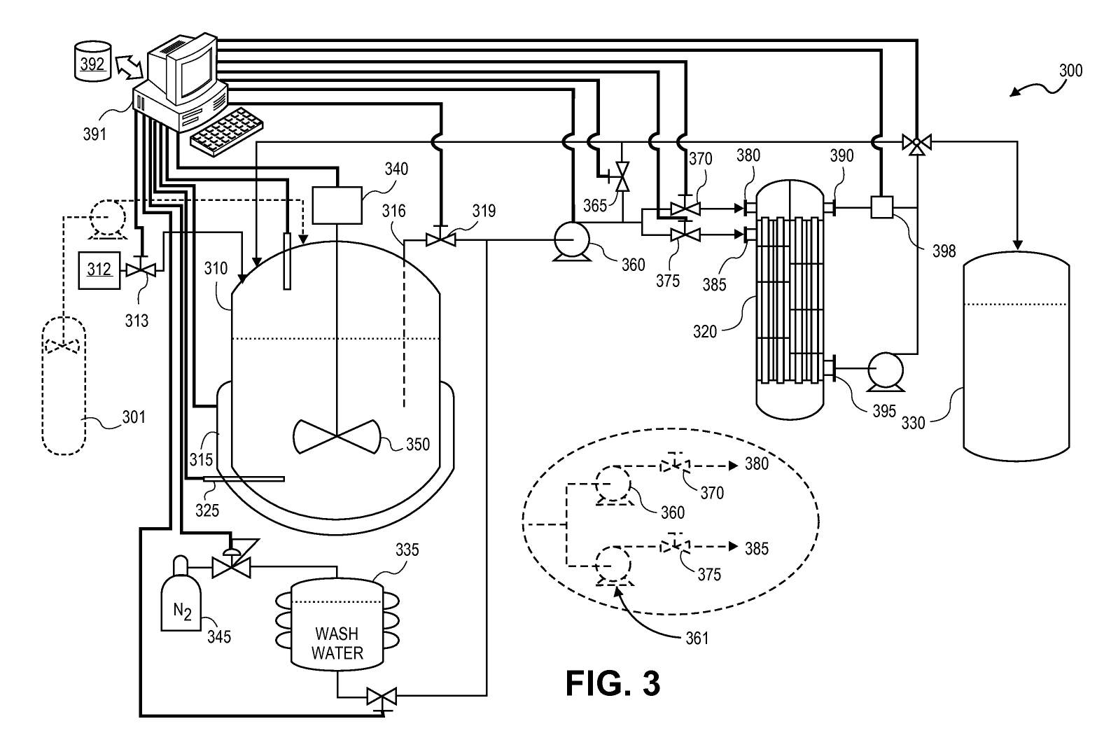

FIG. 3 shows a schematic of an embodiment of a reaction system to form a molecular sieve membrane such as the membrane described with reference to FIG. 1 or FIG. 2. Referring to FIG. 3, system 300 includes production chamber or vessel 310, such as an autoclave. Production chamber 310, in one embodiment, is a vessel defining an interior volume sufficient to contain sufficient molecular sieve material to supply at least one reaction chamber and that may be sealed to maintain an elevated pressure created by the preparation of molecular sieve material for a synthesis reaction. A steel vessel (e.g., stainless steel) is one example of a suitable vessel.

Production chamber 310 defines a volume sufficient to accommodate a volume of molecular sieve material. A molecular sieve containing membrane, such as a SAPO or AlPO containing membrane, is formed through hydrothermal treatment of a molecular sieve material including an aqueous SAPO or AlPO material (e.g., gel). In this manner, as used herein, a molecular sieve material, including a SAPO or AlPO material is a material (gel, solution) suitable that when heated under autogenous pressure forms molecular sieve crystals (e.g., SAPO and/or AlPO crystals).

Referring to FIG. 3, production chamber 310 includes heat source 315 to provide heat to contents within a volume of the chamber. Suitable heat sources include, for example, hot oil or steam jacketing or electrical (resistive) heating. Also connected to the chamber is mixer 340 with impeller 350 disposed in the chamber to stir/mix contents within the chamber.

U.S. Pat. No. 7,316,727 describes a process of preparing a SAPO-34 molecular sieve material. That process is incorporated herein in its entirety. In one embodiment, the material is prepared by mixing sources of aluminum, phosphorus, silicon, and oxygen in the presence of templating agent and water. The composition of the mixture may be expressed in terms of the following molar ratios as: 1.0 Al₂O₃:aP₂O₅:bSiO₂:cR:dH₂O, where R is a templating agent or multiple templating agents. The term “templating agent” or “template” refers to a species added to synthesis media to aid in and/or guide the polymerization and/or organization of the building blocks that form the crystal framework. In one embodiment, R is a quaternary ammonium templating agent. In one embodiment, the quaternary ammonium templating agent is selected from the group consisting of tetra alkyl ammonium salts such as tetrapropyl ammonium hydroxide (TPAOH), tetrapropyl ammonium bromide, tetrabutyl ammonium hydroxide, tetrabutyl ammonium bromide, tetraethyl ammonium hydroxide (TEAOH), tetraethyl ammonium bromide, or combinations thereof. In other embodiments, one of the templating agents may be a free amine such as dipropyl amine (DPA). In one embodiment, crystallization temperatures suitable for crystallization are between about 420 K and about 520 K, a is between about 0.1 and about 1.5, b is between about 0.00 and about 1.5, c is between about 0.2 and about 10 and d is between about 10 and about 300. If other elements are to be substituted into the structural framework of the SAPO, the gel composition can also include Li₂O, BeO, MgO, CoO, FeO, MnO, ZnO, B₂O₃, Ga₂O₃, Fe₂O₃, GeO, TiO, NiO, As₂O₅ or combinations thereof.

In one embodiment suitable for crystallization of SAPO-34, c is less than about 4. In one embodiment suitable for crystallization of SAPO-34 at about 493 K for about 6 hours, a is about 1, b is about 0.3, c is about 2.6 and d is about 150. In one embodiment, R is a quaternary organic ammonium or organic amine templating agent or combinations thereof. Examples of quaternary ammonium templating agents include but are not limited to tetrapropyl ammonium hydroxide and tetraethyl ammonium hydroxide (TEAOH). Examples of organic amines include but are not limited to alkyl amines such as dipropyl amine (DPA).

U.S. Pat. No. 4,440,871 describes a process for forming silicon-substituted aluminophosphates including SAPO-34. That process is also incorporated herein in its entirety as another representative molecular sieve material.

In one embodiment, the molecular sieve material is prepared by mixing sources of phosphate and alumina with water for several hours in production chamber 310 before adding the template. The mixture is then stirred before adding the source of silica. FIG. 3 shows mixer 340 connected to chamber 310 with impeller 350 connected to mixer 340. In one embodiment, the source of phosphate is phosphoric acid. Suitable phosphate sources also include organic phosphates such as triethyl phosphate, and crystalline or amorphous aluminophosphates. In one embodiment, the source of alumina is an aluminum alkoxide, such as aluminum isopropoxide. Suitable alumina sources also include aluminum hydroxides, pseudoboehmite and crystalline or amorphous aluminophosphates (gibbsite, sodium aluminate, aluminum trichloride). In one embodiment, the source of silica is a silica sol. Suitable silica sources also include fumed silica, reactive solid amorphous precipitated silica, silica gel, alkoxides of silicon (silicic acid or alkali metal silicate).

In one embodiment, the molecular sieve material is aged prior to use. As used herein, an “aged” material is a material that is held (not used) for a specific period of time at a specific temperature after all the components of the material are mixed together. In one embodiment, the molecular sieve material is sealed in production chamber 310 and stirred during aging to prevent settling and the formation of a solid cake. Without wishing to be bound by any particular theory, it is believed that aging of the material affects subsequent crystallization of the material by generating nucleation sites. In general, it is believed that longer aging times lead to formation of more nucleation sites. The aging time will depend upon the aging temperature selected.

After initial mixing of the components of the molecular sieve material in production chamber 310, material can settle to the bottom of the chamber. In one embodiment, the molecular sieve material is stirred and aged until no settled material is visible at the bottom of production chamber 310 and the material appears substantially uniform to the eye if viewed through a sight glass in the production chamber or if sampled from the production vessel.

In different embodiments, the aging time at 25° C. to 60° C. is at least about 12 hours, greater than about 24 hours, at least about 48 hours, and at least about 72 hours. For SAPO-34 membranes, in different embodiments the aging time at 25° C. to 60° C. can be at least about 12 hours, at least about 48 hours, and between about one day and about seven days.

Once a molecular sieve material is aged in production chamber 310, the molecular sieve material (synthesis gel) is heated via heat source 315 to a predetermined temperature that is, for example, a synthesis reaction temperature for forming molecular sieve crystals in or on a support. At the predetermined temperature, the molecular sieve material is transferred from production chamber 310 to reaction chamber 320. Production chamber 310 is in fluid communication with reaction chamber 320.

In another embodiment, the molecular sieve material is prepared and aged in a vessel other than production chamber 310 and then transferred (e.g., pumped) to production chamber 310 and then heated to a synthesis reaction temperature. As noted, the aging process can take considerable time, e.g., 24 hours or more. By preparing and aging molecular sieve material in a chamber other than production chamber 310, production chamber 310 can be committed to a synthesis reaction process. FIG. 3 shows optional aging vessel 301 in dashed lines having an outlet and being in fluid communication with production chamber 310.

In another embodiment, a concentrated molecular sieve material is prepared with a lower water concentration (i.e., d_{aging}<d_{final} in a vessel other than the production vessel 310. This concentrated gel is aged at a specific temperature and maintained for a specific period after which the aged concentrated gel is transferred to the production chamber 310 where sufficient water is added to the gel to bring the concentration to the desired final concentration (i.e., d_{final}) prior to heat up to reaction temperature.

FIG. 3 shows production chamber 310 having outlet 316 and being in fluid communication with reaction chamber 320. Representatively, a conduit (e.g., stainless steel piping) may lead from production chamber 310 to reaction chamber 320. Transfer of molecular sieve material from production chamber 310 to reaction chamber 320 may be assisted by pump 360 disposed between outlet 316 of production chamber 310 and reaction chamber 320. A single reaction chamber is shown in FIG. 3 and described herein. It is appreciated that two or more reaction chambers may be connected in the same manner in parallel, or in series, to production chamber 310. An advantage to having multiple reaction chambers connected to production chamber 310 is increased processing efficiency in that formation of membranes can proceed in multiple reaction chambers at one time and a reaction chamber can be isolated (e.g., to remove membranes or insert supports) while processing continues in another reaction chamber or chambers. Reaction chambers can be connected in series in an embodiment where the residence time of a molecular sieve material in a first chamber is such that the molecular sieve material is not completely spent as the material leaves the first reaction chamber and can subsequently be used in a second reaction chamber to form a membrane or make powder before, for example, it is returned to production chamber 310.

It is appreciated that the predetermined temperature of the molecular sieve material in production chamber 310 referenced above may be greater or less than a reaction temperature for forming a membrane. It might be greater, for example, if the distance between production chamber 310 and reaction chamber 320 will result in a larger than desired loss of heat from the molecular sieve material. In another embodiment, reaction chamber 320 includes a heat source (e.g., an external heat source). Such heat source may be used to maintain a desired reaction temperature in reaction chamber 320. Where a heat source is associated with reaction chamber 320, the predetermined temperature of the molecular sieve material in production chamber 310 may also be different than a reaction temperature for forming a membrane since the material can be heated once it is in reaction chamber 320.

Reaction chamber 320 is, for example, a stainless steel vessel defining a volume sufficient to accommodate one or more molecular sieve membrane supports such as a porous support or supports as described with reference to FIG. 1 and FIG. 2. Representatively, reaction chamber 320 is a sealable chamber to allow a synthesis reaction to occur at an autogenous pressure. In one embodiment, a design of reaction chamber 320 is similar to a shell and tube heat exchanger, with a removable tube bundle. A floating head pull through type heat exchanger design would allow the removal of the complete tube (support or supports) bundle and the insertion of another bundle in its place for quick turnaround. Individual tubes (supports) could also be removed. Fixed tubesheet designs with removable tubes may be also used where a shell side could be cleaned by chemical agents alone.

In one embodiment, reaction chamber 320 simulates a shell and tube heat exchanger design with the support or multiple supports serving as the tubes (e.g., a bundle of multiple supports in the heat exchanger). Representatively, reaction chamber 320 resembles a shell and tube heat exchanger, with a removable tube bundle.

Reaction chamber 320 includes inlet 380 and inlet 385 and outlet 390 and outlet 395. When a molecular sieve membrane support or supports is accommodated in reaction chamber 320, inlet 380 is positioned to be in fluid communication with a bore or lumen side of the membrane support and inlet 385 is positioned to be in fluid communication with a shell or exterior side of the support. Baffles may be included in reaction chamber 320 that extend from an interior wall to manipulate a flow of molecular sieve material in reaction chamber 320 and to provide a better means by which to align the membranes into the reaction chamber during installation.

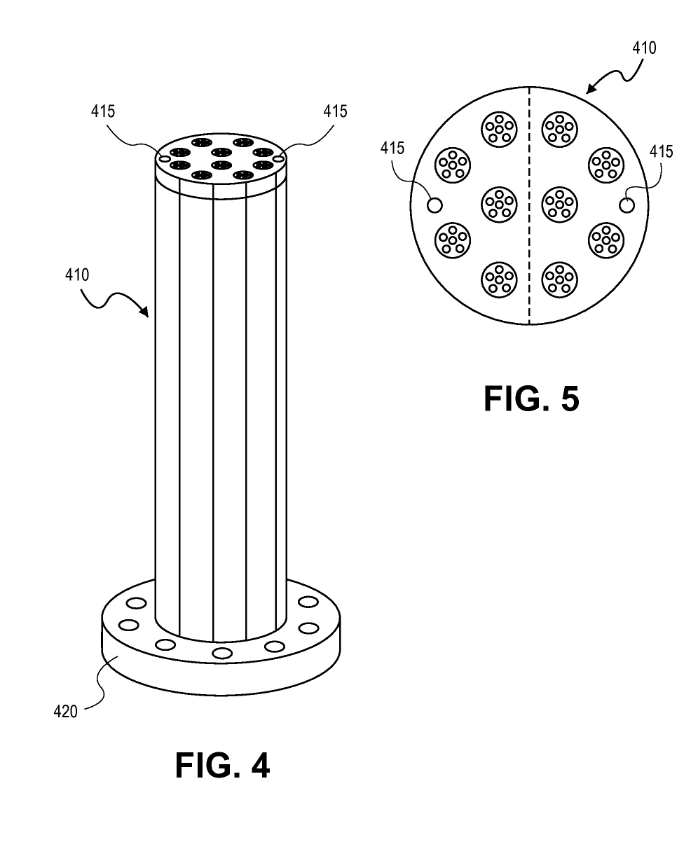

FIG. 4 shows a representation of ten molecular sieve membrane supports assembled in a tube bundle that may be accommodated in reaction chamber 320 such as described. Tube bundle 410 in FIG. 4 is connected to stationary head flange 420. A floating head flange is not shown in FIG. 4. FIG. 5 shows a top view of tube bundle 410 having ten molecular sieve membrane supports. As illustrated, each support is a multiple lumen or channel support. As illustrated in FIG. 5, the ten supports are divided with five supports defining one half of the tube bundle and the other five supports defining the other half. Tube bundle 410 optionally also includes support rods (sometimes referred to as tie rods in heat exchanger nomenclature) 415 of, for example, a metal material such as stainless steel. Support rods 415 provide support to the bundle and aid in attachment to a floating head flange and a stationary head flange.

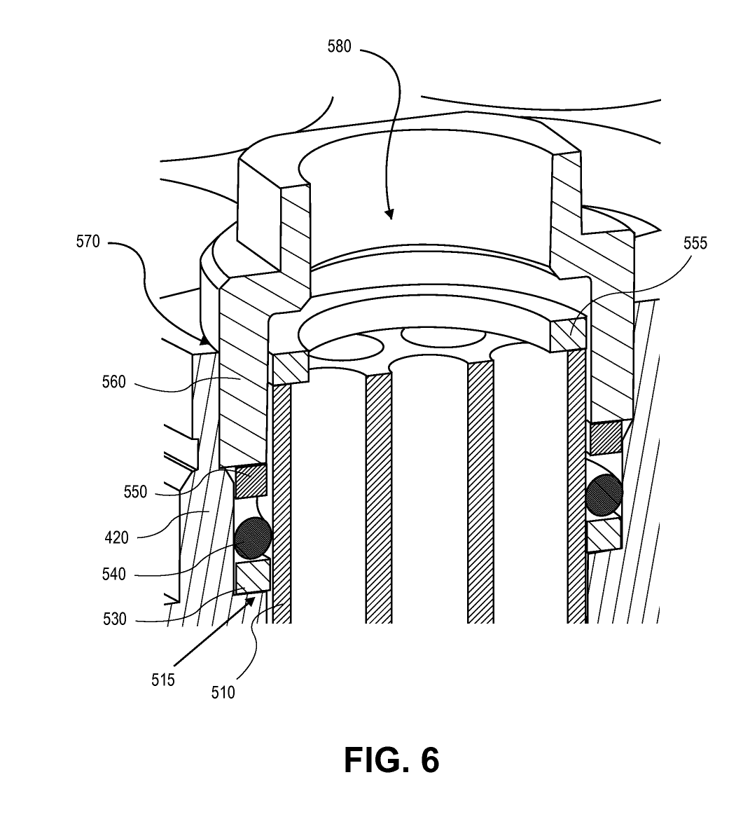

A tube bundle within reaction chamber 320 may include one or more supports. As noted, in one embodiment, the design is based on a shell and tube heat exchanger assembly. The supports, as a tube bundle, are stationary within reaction chamber 320. Accordingly, in one embodiment, the tube bundle of one or more supports is connected to flanges at opposite ends. Molecular sieve material will be introduced into reaction chamber 320 to the bore side and the shell side as a liquid or gel. In one embodiment, an effort is made to minimize leakage at the connection between the tube bundle and the flange. FIG. 6 shows one embodiment of connecting a support to a flange. The flange may be either a floating head flange or a stationary head flange.

Referring to FIG. 6, flange 420 is a generally cylindrical body that includes one or more threaded openings 570 having an inside diameter slightly greater than an outside diameter of support 510. In one embodiment, a representative support may have an outside diameter on the order of 25 millimeters. Accordingly, an opening in flange 420 through which the support may be disposed has an inner diameter on the order of 25.5 millimeters. Referring to FIG. 6, an inner diameter of flange 420 may be defined by ledge 515 protruding laterally from a side surface of the flange to minimize the diameter relative to a diameter of the flange opening distal or above (as viewed) ledge 515. Mounted on ledge 515 within opening 570 of flange 420 is backup ring 530. In one embodiment, backup ring 530 is selected to have an inside diameter approximating that of an outside diameter of support 510. Backup ring 530 may be placed in opening 570 within flange 420 prior to the insertion of support 510 through opening 570. Alternatively, backup ring 530 may be inserted once support is positioned within flange 420. Backup ring 530 is, in one embodiment, a metallic or polymeric ring, such as a PTFE ring, having a thickness on the order of a few to several millimeters.

Overlying backup ring 530 in the opening within flange 420 is O-ring 540. O-ring 540, in one embodiment, is a tubular ring. In one embodiment, O-ring 540 is an elastic material, such as Kalrez® or PTFE, that has an inside diameter greater than an outside diameter of support 510, or that can be expanded to diameter greater than an outside diameter of support 510, and can be maneuvered over support 510 and into the opening within the flange to a position above backup ring 530 (as viewed).

Overlying O-ring 540 in the illustration in FIG. 6, in one embodiment, is optional filler ring 550. Filler ring 550 is a metallic or polymeric material (e.g., PTFE) and is intended to act as a spacer between a screw cap and O-ring 540. A thickness of filler ring 550 will vary depending on any desired space to be filled. Also shown in FIG. 6 is support ring 555. Support ring 555 has an outside diameter, in one embodiment, similar to an outside diameter of support 510. Support ring 555 rests on an end (superior surface as viewed) of support 510. Support ring 555 serves, in one embodiment, to protect support 510 from damage caused by a screw cap that fixes the support to the flange. Referring to FIG. 6, overlying the rings and supports in this view is screw cap 560. Screw cap 560 is, for example, a stainless steel cap having an opening therethrough and an exterior side portion that is threaded. The opening in flange 420 is threaded at a superior (as viewed) portion of the opening. In this manner, screw cap 560 may be threaded into the opening in the flange by the threads on an exterior surface of screw cap 560 with the threads within threaded flange 420 within opening 570. Screw cap 560 is screwed into the opening and depresses optional filler ring 550 and O-ring 540. The depression of O-ring 540 causes the O-ring to hold support 510 and seal the opening (e.g., seal the connection between support 510 and opening 570 within the flange).

The above description of attaching a support to a flange is repeated for each flange (e.g., floating head flange and stationary head flange). Similarly, in an embodiment where there are multiple supports within a tube bundle, such connection of supports to respective flanges is repeated for each support. It is appreciated that the use of a backup ring or a filler ring for each flange connection is a representative embodiment. Each flange need not incorporate a backing ring or a filler ring or involve equivalent connections as another flange in reaction chamber 320.

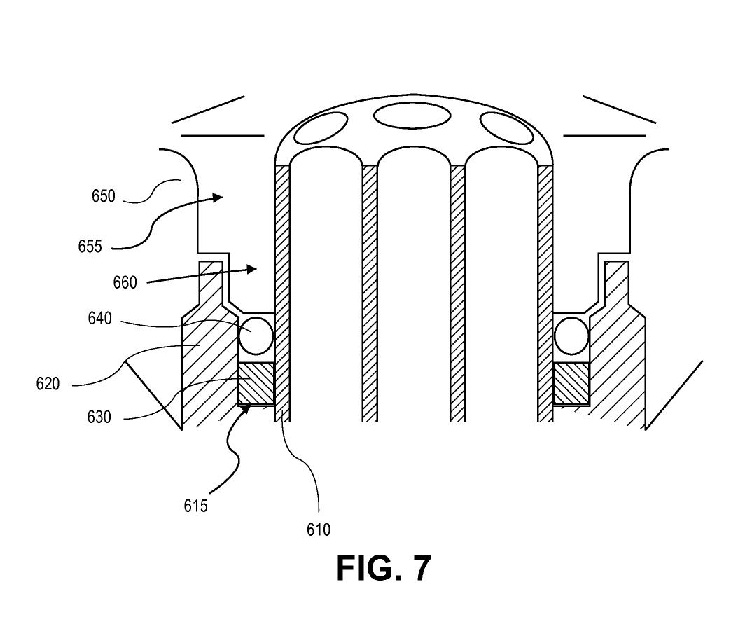

FIG. 7 shows a cross-sectional illustration of another embodiment of attaching a flange to a support. In this embodiment, two flanges are utilized at an end of the support. Referring to FIG. 7, an end of support 610 is positioned through an opening in first flange 620 so that a portion of the support extends through the opening. First flange 620 may be similar in construction to flange 420 in FIG. 6, including inwardly protruding ledge 615 that narrows the opening in first flange 620 to a diameter similar to an outer diameter of support 610. Mounted on ledge 615 is backup ring 630 of, for example, a polymeric material on the order of a few to several millimeters thickness. Backup ring 630 has an inside diameter approximating that of an outside diameter of support 610.

Overlying backup ring 630 within the opening in first flange 620 is O-ring 640. O-ring 640, in one embodiment, is a tubular ring of an elastic material. An inside diameter of O-ring 640 is greater than an outside diameter of support 610 and can be maneuvered over support 610 and into the opening within first flange 620 above backup ring 630 (as viewed).

Overlying O-ring 640 in the illustration in FIG. 7 in this embodiment is second flange 650. Second flange 650 includes generally cylindrical body 655 having an opening or openings there through. The opening or openings have a diameter approximately equal to the outside diameter of a support. A body portion of second flange also includes a cylindrical projection(s) 660 projecting from a surface of cylindrical body 655 and defining an opening through the flange. As viewed in FIG. 7, cylindrical projection 650 projects downward and has a dimension to mate with first flange 620. The mating of first flange 620 and second flange 650 depresses O-ring 640 which holds support 610 and seals the opening in the flange.

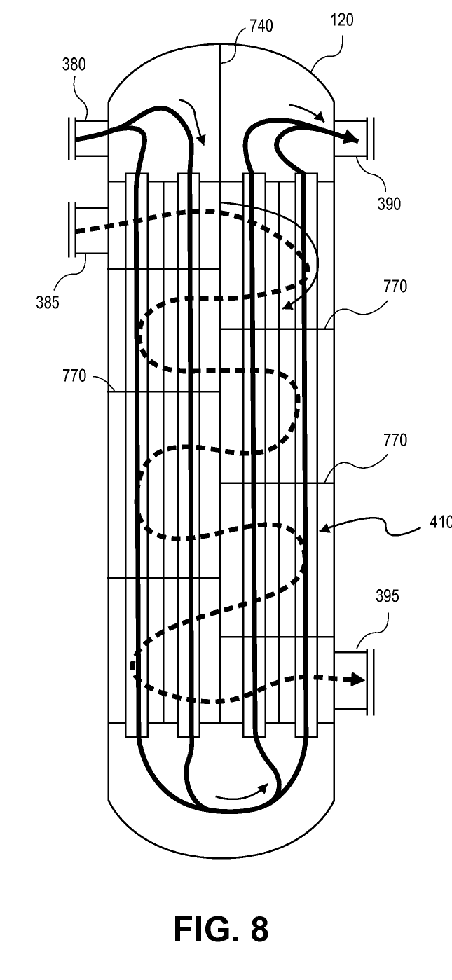

FIG. 8 shows a schematic cross-sectional illustration of tube bundle 410 in reaction chamber 320 (see FIG. 3) to illustrate a flow path of molecular sieve material through the reaction chamber. Referring to FIG. 8, an inner volume of reaction chamber 320 includes divider 740 (a baffle) at the stationary head end of the chamber. When tube bundle 410 (FIGS. 4 and 5) is accommodated in reaction chamber 320, divider 740 will align with the midpoint of the tube bundle so that, as viewed, half of the supports are on the inlet side of reaction chamber 320 (i.e., an inlet side of divider 740 with inlet defined by inlet 380 and inlet 385). The other half of supports of tube bundle 410 is aligned on an outlet side of reaction chamber 320 (i.e., outlet defined by outlet 390 and outlet 395). In one embodiment, where reaction chamber 320 has a design based on a heat exchanger with a floating heat design, inlet 380, inlet 385 and outlet 390 of reaction chamber 320 are disposed toward the stationary head portion of the chamber and outlet 395 is disposed at the floating head portion of the chamber. Molecular sieve material entering reaction chamber 320 through inlet 380 is introduced into a bore side of half of the supports of tube bundle 410. The molecular sieve material will flow or will travel from the stationary head end of reaction chamber 320 towards the floating head end of the chamber. After entering the bore side of the supports, molecular sieve material will contact the support and then flow to the floating head end of reaction chamber 320. The flow is redirected at the floating head end of reaction chamber 320 to the supports on the outlet side of reaction chamber 320. There the molecular sieve material will enter the bore side of the supports on the outlet side of reaction chamber 320, contact the supports and then be directed out of reaction chamber 320 at outlet 390 at a stationary head end of the chamber.

In one embodiment, it is desired that molecular sieve material crystallize on/in only the bore side or the lumen side of the support. This may be achieved by “seeding” only the bore side (the lumen side) of the support and leaving the shell side (the exterior side) of the support unseeded. Without wishing to be bound by theory, “seeding” is a process wherein a surface of the support is contacted with molecular sieve crystals to provide crystallization nuclei for the molecular sieve material during the synthesis to form a membrane (e.g., during a hydrothermal contact between the molecular sieve material and the support).

Another method to inhibit crystallization of molecular sieve material on the shell side (the exterior side) of a support is to coat or cover the shell side with a material that will inhibit crystallization. In one embodiment, prior to assembling the supports into a tube bundle (e.g., tube bundle 410) and placing them in reaction chamber 320, an exterior or outer surface of each support is coated (covered) with a material that will inhibit crystallization of molecular sieve material on the exterior or outer side of the support. In one embodiment, a support is encased in a thin layer of polytetrafluoroethylene (PTFE) that acts as a barrier material to inhibit the formation of an external membrane layer on the exterior of the support. A suitable PTFE layer is produced by wrapping PTFE tape on the exterior of the support. A second suitable layer is a PTFE shrink wrap that is applied by wrapping a heat-shrinkable PTFE sheet around the outside of a support and heating the support to a suitable temperature to contact (e.g., complete contact) a PTFE sheet to an outer surface of a support. In one embodiment, a suitable temperature is about 340° C. (when a suitable PTFE shrink wrap such as that as supplied by Zeus Industrial Products of Raritan, N.J. is used).

It is appreciated that a protective layer such as a PTFE layer on the exterior of a molecular sieve membrane support may not produce a perfect seal. Since the supports are porous, there will likely be a flow path of molecular sieve material from the lumen or bore side of the supports to the exterior of the supports within reaction chamber 320. Accordingly, in one embodiment, system 300 is designed so that molecular sieve material is introduced not only on the bore side of the support but also on the exterior or shell side of the support. Referring to FIG. 3, molecular sieve material from production chamber 310 is transferred from outlet 316 of the production chamber through pump 360 and split into two streams. One stream is directed to the bore side of tube bundle 410 through inlet 380 in reaction chamber 320 and the other stream is directed to inlet 385 in reaction chamber 320 that is in fluid communication with a shell side of the tube bundle. As shown in FIG. 8, molecular sieve material enters inlet 385 on a shell side of tube bundle 410 and circulates through reaction chamber 320 from the stationary head end and toward a floating head end and then exits through outlet 395 in reaction chamber 320. As illustrated, several baffles 770 may be positioned within a volume of reaction chamber 320 to direct the flow of molecular sieve material on the bore side of the tube bundle. In another embodiment, molecular sieve material from production chamber 310 is introduced to reaction chamber 320 in a single input to feed both a bore side and shell side of the tube bundle. Optionally, fluid may be allowed to completely bypass reaction chamber 320 through by-pass valve 365 which is in fluid communication with production chamber 310.

Using molecular sieve material as the bore and shell side medium has several advantages. First, if molecular sieve material leaks through either the tube wall of the supports or through imperfect seals along the tube flange, then there is no risk of contamination of the molecular sieve fluid. Without the use of the molecular sieve material as a heating fluid, the heat lost in the molecular sieve material may lead to temperatures at the support surface that are unacceptable for proper membrane growth or lead to concentration gradients that lead to non-homogeneous membrane growth. Using a high flow rate of molecular sieve material as an additional heating medium allows for better heat control at the support surface.

By splitting a molecular sieve material stream into two streams (one bore and one shell), the flow rate of each stream may be controlled. For example, the bore side stream feeding the bore side of a tube bundle (a stream of molecular sieve material introduced through inlet 380 of reaction chamber 320) can have a relatively low flow rate to pass through the lumens of the supports. A second stream of higher flow (a stream of molecular sieve material introduced at inlet 385 of reaction chamber 320) can have a relatively higher flow rate which will minimize the heat loss from such stream and aid in the temperature control of the tube bundle. One way to control the flow rate of molecular sieve material to inlet 380 and inlet 385 of reaction chamber 320 is by controlling valve 370 and valve 375 disposed between pump 360 and inlet 380 and inlet 385, respectively. In another embodiment, two or more individual pumps could be used instead of single pump 360 to control different flow rates with, for example, separate pumps disposed between outlet 316 and inlet 380 and inlet 385, respectively. In the dashed line inset in FIG. 3, a representative example shows another embodiment where pump 360 feeds inlet 380 and pump 361 feeds inlet 385.

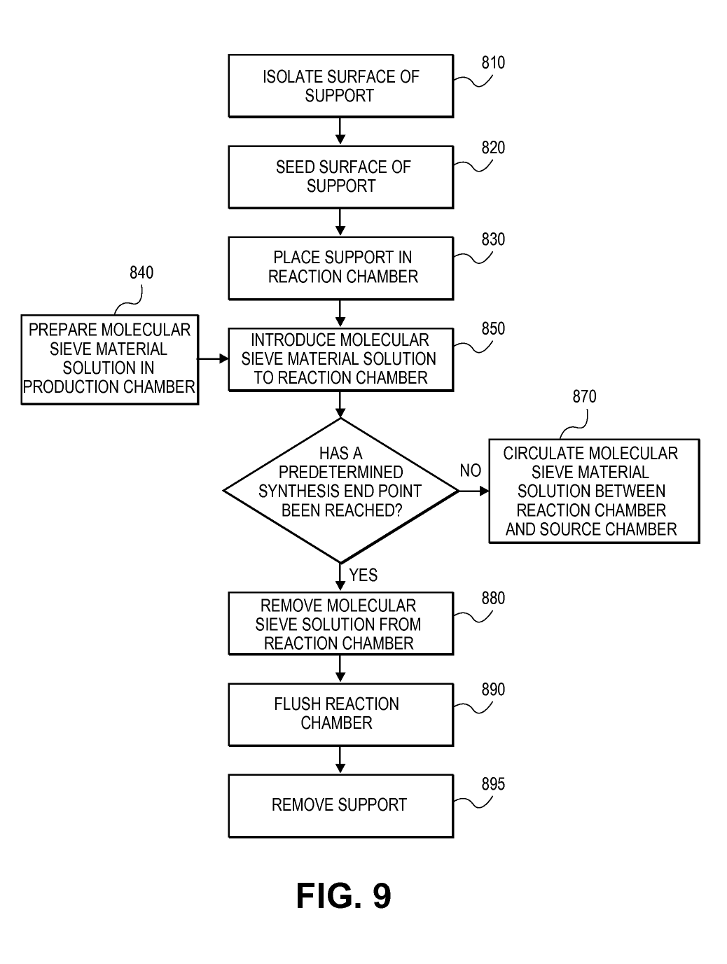

FIG. 9 presents a flow chart of a process of forming a membrane including a porous support and a layer or layers of a molecular sieve material such as SAPO and/or AlPO molecular sieve crystals formed in or on the support. The process will be described in reference to the system shown in FIG. 3.

In the example of forming a tubular membrane having SAPO and/or AlPO molecular sieve crystals formed on an interior surface of a lumen or channel, an exterior surface of a support is isolated with a protective layer such as PTFE (block 810, FIG. 9). Following isolation of an exterior surface of a support, an interior surface of the support is contacted with SAPO and/or AlPO molecular sieve crystals (block 820, FIG. 9). This so called “seeding step” can be performed by any method known to those skilled in the art. U.S. Published Application 2007/0265484 refers to a method in which the surface of the support is coated by rubbing a dry powder onto the surface. U.S. Patent Application No. 61/310,491, filed Mar. 4, 2010, and incorporated herein by reference, refers to a method utilizing capillary depth infiltration whereby the support is contacted with a suspension of SAPO crystals. Capillary forces draw the crystals onto the surface and into the pores of the support. The support is then dried to remove the liquid, leaving the SAPO or AlPO crystals.

Seeding can also be accomplished by pumping a dilute solution of SAPO and/or AlPO crystals through the support until a sufficient amount SAPO and/or AlPO crystals are deposited on and in the support.

Another seeding method is to use air or an inert gas as a carrier fluid for SAPO and/or AlPO seed crystals at a specific concentration and that is contacted with the support surface at a specific flow rate.

Another seeding method is to embed SAPO and/or AlPO seed material into the support during the formation of the surface layer of the inorganic or metallic support on which the SAPO and/or AlPO membrane is to be formed.

Seeding a porous support with SAPO and/or AlPO molecular sieve crystals provides a location for subsequent nucleation of SAPO and/or AlPO material (i.e., further crystal growth). In one embodiment, the SAPO and/or AlPO molecular sieve crystals have been previously subjected to a heating or calcining step. In another embodiment, uncalcined crystals (seeds) of SAPO and/or AlPO (e.g., SAPO-34) may be used. Typically, formation of SAPO-34 crystals involves heating at high temperature with air or nitrogen sweep gas to remove templating agents and provide a porous crystal. Calcination often involves temperatures of about 400° C. (673 K) for six hours or more. In the use of SAPO crystals as a seed material, it has been found that such crystals do not need to be calcined to effectively function (e.g., as nucleation sites for further crystalline growth).

In the above-described embodiment, protecting a shell side (an exterior side) of the support is done prior to seeding of the supports. In another embodiment, the seeding of the supports is done prior to protecting the shell side (i.e., block 810 and block 820 in FIG. 9 are reversed).

Following seeding/surface isolation, the support is placed in a reaction chamber such as reaction chamber 320 (block 830, FIG. 9). In an embodiment, where the support is one of multiple supports of a tube bundle, a tube bundle is assembled prior to loading the bundle into the reaction chamber.

Separate to the loading of the support or a tube bundle of supports in a reaction chamber, a molecular sieve material is prepared in a production chamber (block 840, FIG. 9). Such preparation may include aging of the material as described above. In one embodiment, the molecular sieve material is brought to a synthesis temperature in production chamber 310 (FIG. 3). In one embodiment, the synthesis temperature is between about 420 K and about 520 K. In different embodiments, the synthesis temperature is between about 450 K and about 510 K, or between about 465 K and about 500 K.

Once the molecular sieve material is prepared in production chamber 310, the molecular sieve material is introduced to the reaction chamber and brought into contact with at least one surface of the support (block 850, FIG. 9). As described above, such contact may be the introduction of molecular sieve material to the bore side of the support(s) as well as the tube side. The introduction of molecular sieve material into the reaction chamber continues through the synthesis. In one embodiment, the crystallization time is between about one hour and about 24 hours but in a different embodiment, the crystallization time is about 3 to 6 hours. Synthesis typically occurs under autogenous pressure. In other words, the reaction vessel is sealed and the contact of the heated molecular sieve material and the support(s) results in a pressure build up within the reaction vessel.

Following contact with the support(s), molecular sieve material is then delivered to outlet 390 (bore side) and outlet 395 (shell side) of reaction chamber 320. From there, molecular sieve material may be sent to waste or may be returned to production chamber 310. By returning it to production chamber 310, a circular reaction system is described. FIG. 3 shows a path from each of outlet 390 and outlet 395 of reaction vessel 320 to production chamber 310. This circulation continues until a predetermined synthesis endpoint is reached on the support(s) in reaction chamber 320 (block 870, FIG. 9). In one embodiment, a predetermined synthesis endpoint is the formation of a desired crystalline layer (SAPO and/or AlPO crystalline layer) on the support or supports within reaction chamber 320 to define a membrane.

Once a predetermined synthesis endpoint has been reached, production chamber 310 and reaction chamber 320 may be isolated from each other and the molecular sieve material can be removed from reaction chamber 320 (block 880, FIG. 9). In this manner, pump 360 may be stopped and valves 319, 370 and 375 closed. Remaining molecular sieve material in reaction chamber 320 may then be flashed through a condenser (not shown) and transferred to receiver 330. By isolating production chamber 310 and reaction chamber 320 following the predetermined synthesis end point, and flashing and condensing molecular sieve material remaining in reaction chamber 320, a significant thermal mass is removed from reaction chamber 320, thereby quickly cooling the membrane or membranes within reaction chamber 320 and removing a portion of spent molecular sieve material that can cause dissolution of the crystalline layer of the membrane. Alternatively, molecular sieve material is not flashed directly, but removed via pressurized water from vessel 335. Pressure is provided, for example, via nitrogen overpressure from vessel 345. At production chamber 310, when isolated, any free amines could be flashed from production chamber 310 through a condenser (not shown). Such flashing removes volatile amines from the system.

Returning to reaction chamber 320, after removing the remaining molecular sieve material in the chamber, water may be flushed through reaction chamber 320 to finish removing synthesis gel and to remove any excess molecular sieve material and cool the membrane or membranes (block 890, FIG. 9). Alternatively, water may be flushed through reaction chamber 320 to remove molecular sieve material without previously flashing the contents of the reaction chamber. Representatively, water may be stored in injection tank 335 under nitrogen over pressure (via nitrogen source 345), which provides the driving force to push solid side products and spent molecular sieve material into receiver 330. In one embodiment, to inhibit thermal shock damage to membranes in reaction chamber 320, water in tank 335 may be heated to, for example, 175° C. Following the flushing, the membrane or membranes within reaction chamber 320 may be cooled and then may be removed from reaction chamber 320 and processed according to procedures known in the art (block 895, FIG. 9). Such procedures include rinsing the membrane with water, removal of any protective layer from the support (e.g., removal of the PTFE wrap), drying of the membrane and calcining the membrane(s) to remove any templating agent.

In one embodiment, a system including the formation and transfer of molecular synthesis material from production chamber 310 to reaction chamber 320 or multiple reaction chambers may include an automated processing system. FIG. 3 shows control computer 391 in communication with the various system components to provide a centralized user interface for controlling the components and a synthesis reaction. It shall be appreciated that control computer 391 and the various system components may be configured to communicate through hardwires or wirelessly, for example, the system may utilize data lines which may be conventional conductors or fiber optic.

Control computer 391 may also communicate with one or more local databases 392 so that data or protocols may be transferred to or from local database(s) 392. For example, local database 392 may store one or a plurality of synthesis protocols, flashing protocols, and washing protocols that are designed to be performed by the components of system 300. Furthermore, control computer 391 may use local database(s) 392 for storage of information received from components of system 300, such as reports and/or status information.

Representatively, as described above, production chamber 310 is used, in one embodiment, to produce a molecular sieve material suitable for reacting with a support or supports in reaction chamber 320. In producing the molecular sieve material, various components are added, mixed, heated and aged as described above. In one embodiment, the addition of the components may be monitored and/or controlled by control computer 391. For example, a processing protocol delivered to control computer 391 includes instructions for preparing a batch of a SAPO-34 molecular sieve material by mixing sources of aluminum, phosphorous, silicon and oxygen in the presence of a templating agent(s) and water. These instructions are provided in a machine-readable form to be executed by control computer 391. Accordingly, control computer 391 executes the instructions to meter the components into production chamber 310 from individual storage containers (collectively shown in FIG. 3 as container 312 so as not to obscure the illustration). Such metering is controlled and monitored by control computer 391 by, for example, opening valve 313 to deliver a component to reaction chamber 320 through, for example, a flow meter in communication with control computer 391.

Once the desired components are in production chamber 310, in one embodiment, control computer 391 includes a processing program for preparing the molecular sieve material. Control computer 391 may, for example, control the preparation by controlling mixer 340 for mixing rates and times, controlling heater 315 for temperature requirements with feedback from temperature sensor 325, and monitoring an internal clock for processing and ageing time. Such control may be through machine-readable instructions implemented in control computer 391 connected to process control modules associated with mixer 340 and heater 315.

When a molecular sieve material is prepared in production chamber 310 and ready for transfer to reaction chamber 320, in one embodiment, control computer 391 controls output valve 319 (actuates valve open) and pump 360 to transfer the material. Similarly, control computer 391 controls input valve 370 and input valve 375 of reaction chamber 320. As described above, in one embodiment, it is desired that the flow rate of molecular sieve material introduced to a bore side of the support(s) in reaction chamber 320 be different (be less) than a flow rate of molecular sieve material introduced to a shell side of the support(s). Representatively, control computer 391 controls the flow rate to the bore and shell sides of the supports by actuating input valve 370 differently than input valve 375 (e.g., input valve 375 is opened to a greater degree than input valve 370). In one embodiment, flow meters associated with the valves (e.g., on a distal side of the valves) may provide feedback to control computer 391 regarding the selected flow rates.

In one embodiment, control computer 391 also monitors and controls a synthesis reaction within reaction chamber 320. One way that this may be done is by monitoring a pH of the molecular sieve material as it is transferred out through exit port 390. As described above, as molecular sieve material reacts with the support(s) to form molecular sieve crystals in or on a support, the pH of the molecular sieve material (the spent molecular sieve material) changes. In one embodiment, the pH may be measured at pH meter 398 distal to exit port. This information is fed to control computer 391. Control computer may include a program for evaluating the pH data and changing parameters such as stirring speed, flow rate, and temperature to optimize synthesis conditions. Alternatively, aliquots of molecular sieve material can be removed from the production vessel and analyzed externally using methods such as x-ray diffraction to monitor the degree of crystallinity of the crystals formed.

Once the synthesis reaction is complete, control computer 391 includes machine-readable instructions to stop the transfer of molecular sieve material from production chamber 310 (by, for example, stopping pump 360 and shutting valve 319, input valve 370 and input valve 375). At this point, a protocol may provide executable instructions for control computer 391 to drain reaction chamber 320, flash and flush it with water. Alternatively, molecular sieve material can continue to circulate by opening bypass control valve 365 and closing valves 370 and 375 while still isolating the reaction chamber 320.

The separation of a production chamber to produce a molecular sieve material and a reaction chamber to react the produced molecular sieve material with a support provides a variety of benefits. These benefits include a more uniform or consistent molecular sieve material for a synthesis reaction since the material is prepared and mixed separately and transiently introduced to the reaction chamber, allowing for uniform mixing inside of the supports.

If, for example, supports are placed in a reaction vessel containing an impeller to provide mixing, the reaction dynamics between the material and a support differ depending on a position relative to the impeller and the type of impeller. According to the system described herein, there is no requirement for an impeller in the reaction chamber which eliminates the differing reaction dynamics inside each lumen. Additionally, the reactions described herein occur at elevated pressure. Commercial autoclaves are not typically designed for the facile removal of large solid objects. If a single vessel (such as an autoclave), equipped with a stirrer and impeller is used as the reaction chamber, without the use of a production chamber, then the supports must be strategically oriented in the autoclave to avoid damage to the supports and optimize mixing around the surface, likely resulting in a larger, more costly vessel. Additionally, addition and removal of the supports from a larger, single stirred vessel is expected to present more technical and logistical challenges (e.g. loading and unloading) due to size and weight of the vessel.

Another benefit of employing separate reaction and production vessels is the ability to rapidly isolate a membrane or membranes from the molecular sieve material after the synthesis reaction. This allows for cooling the membrane(s) and inhibiting its degradation.

Separate autoclave reaction and membrane production vessels also provide the ability to modify a synthesis reaction during a reaction or between syntheses. Modifying a reaction during a reaction might include changing a flow rate of molecular sieve material to the reaction chamber to, for example, increase or decrease a rate of reaction. Modifying a reaction between syntheses might include a change in the reaction temperature or flow rate depending on the number of supports to be contacted or whether the supports are single channel or multichannel.

A still further benefit that the separation of a production chamber and a reaction chamber provides is the production of molecular sieve crystals (e.g., SAPO or AlPO crystals) (“microcrystalline sieve powder”) as waste or by-product and the ability to harvest such microcrystalline sieve powder, for future seeding or other commercial uses. As described, the reaction chamber can be immediately isolated from the production chamber after a synthesis reaction and the spent molecular sieve material removed from the reaction chamber on subsequent flushing. Crystals produced during synthesis that do not form part of the membrane upon washing may be reacted further to increase their crystallinity and to target other specific desirable characteristics. Additional reagents may also be added to the production chamber to achieve a desirable powder product. In other words, the conditions for forming molecular sieve powder can be different than the conditions that promote crystallization of the molecular sieve material on a support. Once formed, the molecular sieve powder can be retrieved from the reaction chamber. It is appreciated that molecular sieve powder can also be removed from the production chamber.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

1. A method comprising:
preparing a molecular sieve material in a first chamber;
transferring the molecular sieve material from the first chamber to a second chamber comprising at least one support;
in the second chamber, contacting the at least one support with the molecular sieve material under conditions that promote the crystallization of molecular sieve material on the at least one support; and
synthesizing crystals of molecular sieve material on the at least one support.

2. The method of claim 1, wherein transferring of the molecular sieve material from the first chamber to the second chamber continues until a predetermined synthesis end point is reached on the at least one support.

3. The method of claim 2, wherein the molecular sieve material is circulated between the first chamber and the second chamber.

4. The method of claim 2, wherein after a predetermined synthesis end point is reached on the at least one support, the molecular sieve material is removed from the second chamber.

5. The method of claim 4, wherein after a predetermined synthesis end point is reached on the at least one support, the molecular sieve material is transferred from the second chamber to a receiver.

6. The method of claim 1, wherein preparing a molecular sieve material in a first chamber comprises mixing a composition comprising sources of the molecular sieve material with one or more templating agents and heating the composition to a crystallization temperature.

7. The method of claim 1, wherein the molecular sieve material comprises silicon, aluminum, phosphorous (SAPO) material or an aluminophosphate (AlPO) material.

8. The method of claim 1, wherein the support has a length dimension with at least one lumen therethrough and, in the second chamber, an exterior surface of the support defines a shell side and an interior surface of the support defined by the at least one lumen defines a bore side, and contacting the support with the molecular sieve material comprises introducing the molecular sieve material to the bore side of the support.

9. The method of claim 8, further comprising separately introducing the molecular sieve material on the shell side of the support.

10. The method of claim 9, wherein the molecular sieve material introduced on the bore side of the support is introduced at a flow rate that is lower than a flow rate of the molecular sieve material that is introduced on the shell side of the support.

11. The method of claim 1, further comprising forming comprising forming molecular sieve powder separate from the synthesized crystals on the at least one support; and
collecting the molecular sieve powder from one of the first chamber and the second chamber.

12. The method of claim 11, wherein the conditions for forming molecular sieve powder are different than the conditions required to make a sieve membrane on the at least one support.

13. A system comprising:
a first chamber defining a volume sufficient to accommodate a volume of molecular sieve material, an inlet and an outlet;
a heating element coupled to the first chamber; and
a second chamber comprising a pair of inlets and defining a volume sufficient to accommodate a support having a length dimension with at least one lumen therethrough, an exterior surface of the support defining a shell side and an interior surface of the support defined by the at least one lumen defining a bore side,
wherein, when a support is accommodated in the second chamber, a first of the pair of inlets of the second chamber is positioned to be in fluid communication with a bore side of the support and a second of the pair of inlets is positioned to be in fluid communication with a shell side of the support, and
wherein the outlet of the first chamber is in fluid communication with the pair of inlets of the second chamber.

14. The system of claim 13, wherein the second chamber comprises a pair of outlets and each of the pair of outlets is in fluid communication with the inlet of the first chamber.

15. The system of claim 13, further comprising a third chamber defining a volume, wherein the second chamber comprises a pair of outlets and each of the pair of outlets is in fluid communication with the third chamber.

16. The system of claim 15, wherein the pair of outlets are selectively in fluid communication with the first chamber and the third chamber.

17. The system of claim 13, further comprising a pump coupled to the outlet of the first chamber.

18. The system of claim 13, further comprising a first valve coupled to a first of the pair of inlets of the second chamber configured to control a flow rate of a molecular sieve material through the first of the pair of inlets, and a different second valve coupled to the second of the pair of inlets of the second chamber and configured to control a flow rate of a molecular sieve material through the second of the pair of inlets.

19. The system of claim 13, further comprising a first pump disposed between the outlet of the first chamber and a first of the pair of inlets of the second chamber and a second pump coupled to the second of the pair of inlets of the second chamber.
